(19) United States
(12) Patent Application Publication
(10) Pub. No.: US 2019/0212417 A1
(43) Pub. Date: Jul. 11, 2019

(54) ARCHERY LASER DISTANCE METER AND ASSOCIATED ACCESSORIES

(71) Applicant: Dark Forest Industries, LLC, Atlanta, GA (US)

(72) Inventor: Adam H. Strange, Atlanta, GA (US)

(21) Appl. No.: 16/245,150

(22) Filed: Jan. 10, 2019

Related U.S. Application Data
(60) Provisional application No. 62/615,897, filed on Jan. 10, 2018.

(51) Int. Cl. G01S 7/481; G01S 17/88; F41G 3/06; F41B 5/14

(52) U.S. Cl. CPC G01S 7/4813; F41B 5/1403; F41G 3/06; G01S 17/88

(57) ABSTRACT

A laser distance meter assembly is disclosed. The laser distance meter assembly may include a laser distance meter. The laser distance meter may include at least one housing with a front face and a mounting face. The laser distance meter may also include a set of lasers disposed to emanate from the front face and a housing mount assembly configured to secure the laser distance meter to a bow stabilizer mount. The laser distance meter assembly may include a display removably mounted onto the bow, an actuator switch removably mounted onto the bow, and at least one communication line. The communication line may be configured to transmit information between the actuator switch and the laser distance meter.

### CROSS-REFERENCE TO RELATED APPLICATIONS

The disclosure claims priority to and the benefit of U.S. Provisional Patent Application No. 62/615,897, filed Jan. 10, 2018, which is hereby incorporated by reference herein in its entirety.

### FIELD OF THE DISCLOSURE

The disclosure generally relates to a laser distance meter and more particularly relates to a laser distance meter with a visible laser.

### BACKGROUND

Laser distance meters are configured to measure the distance from the user to a distant target or area. A laser distance meter is a useful tool for various purposes including construction, hunting, golfing, surveying, or even virtual reality. A laser distance meter may be useful for hunting because the information conveyed to the hunter may allow a determination of whether the target was beyond the range of his or her selected weapon, and/or how to properly sight the target based on distance to the target. Current laser distance meters commonly require alignment of a target, the sight, and the user's eye. Setting the alignment between the weapon sights and laser distance meter before use, sometimes referred to as zeroing, may be a time-consuming task. In addition, when in use, it may be a difficult task aligning the sights and laser distance meter because of possible undesirable movement of the hunter and the time needed to lift the weapon into a position where the user can utilize sights to ensure the laser distance meter is pointing at the target.

Traditional laser distance meters have a litany of other deficiencies as well. Commonly, laser distance meters can be unsightly, inefficient, and heavy. First, large housings for laser distance meters may inhibit an archer's field of view. Second, a hunter may have to remove one hand from the bow to activate the rangefinder. This may be time-consuming, and the hunter's eyes and bow may have to realign with the target, which is often undesirable. Third, many laser distance meters may have two modes, on and off. A hunter would, therefore, have to either turn a laser distance meter on each time a target is acquired, or the battery may continuously drain with the laser distance meter on at all times. Finally, traditional laser distance meters may be heavy and disrupt the balance of a firearm, such as a bow. Any unbalancing to a bow can cause the trajectory of a fired arrow to be severely off-target. Thus, many conventional laser distance meters give insufficient means for accurately and effectively measuring distance while operating a bow.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a perspective view of the laser distance meter assembly in accordance with one or more embodiments of the disclosure.

FIG. 2A depicts a front face perspective view of a laser distance meter in accordance with one or more embodiments of the disclosure.

FIG. 2B depicts a mounting face perspective view of the laser distance meter in accordance with one or more embodiments of the disclosure.

FIG. 3A depicts a front face exploded view of the laser distance meter in accordance with one or more embodiments of the disclosure.

FIG. 3B depicts a mounting face exploded view of the laser distance meter in accordance with one or more embodiments of the disclosure.

FIG. 4 depicts a front face view of the laser distance meter in accordance with one or more embodiments of the disclosure.

FIG. 5A depicts an exploded perspective view of the mount housing of the laser distance meter in accordance with one or more embodiments of the disclosure.

FIG. 5B depicts an exploded perspective view of the mount housing of the laser distance meter in accordance with one or more embodiments of the disclosure.

FIG. 6A depicts a perspective view of a mount housing of the laser distance meter in accordance with one or more embodiments of the disclosure.

FIG. 6B depicts a perspective view of the mount housing of the laser distance meter in accordance with one or more embodiments of the disclosure.

FIG. 7A depicts a front view of the mount housing of the laser distance meter in accordance with one or more embodiments of the disclosure.

FIG. 7B depicts a rear view of the mount housing of the laser distance meter in accordance with one or more embodiments of the disclosure.

FIG. 8 depicts a component side view of the laser distance meter in accordance with one or more embodiments of the disclosure.

FIG. 9 depicts a front view of the laser distance meter in accordance with one or more embodiments of the disclosure.

FIG. 10A depicts a front view of a laser distance meter assembly in accordance with one or more embodiments of the disclosure.

FIG. 10B depicts a front view of a laser distance meter assembly in accordance with one or more embodiments of the disclosure.

FIG. 11 depicts a schematic view of the front face of the laser distance meter in accordance with one or more embodiments of the disclosure.

FIG. 12 depicts a perspective view of a communication line of the laser distance meter assembly in accordance with one or more embodiments of the disclosure.

FIG. 13 depicts a front view of a static sight of the laser distance meter assembly in accordance with one or more embodiments of the disclosure.

FIG. 14 depicts a rear view of the laser distance meter in accordance with one or more embodiments of the disclosure.

FIG. 15 depicts an perspective view of a laser distance meter coupled with a visual laser in accordance with one or more embodiments of the disclosure.

FIG. 16 depicts a lower perspective view of the laser distance meter in accordance with one or more embodiments of the disclosure.

FIG. 17 depicts an isometric diagram of a laser distance meter mounted on an archery bow in accordance with one or more embodiments of the disclosure.

FIG. 18 depicts a design view of the laser distance meter in accordance with one or more embodiments of the disclosure.

FIG. 19 depicts a front view of a wireless device of the laser distance meter assembly in accordance with one or more embodiments of the disclosure.

FIG. 20 depicts a front view of a wireless device of the laser distance meter assembly in accordance with one or more embodiments of the disclosure.

### DETAILED DESCRIPTION

Embodiments of the present disclosure relate to a laser distance meter that permits alignment without the need for the three-element sequence. The alignment of the user's eye, the laser, and the target is also known as the three-element sequence. In addition, the laser distance meter may toggle between an on position and a standby position that, when actuated, emanate a series of visible and invisible lasers to a target. That is, the visible laser may permit alignment to the natural eye to a target and the invisible laser may be reflected to a receiver to measure distance to the target.

Traditional embodiments of laser distance meters can be heavy and awkward. The present embodiments encompass a laser distance meter assembly that is configured to balance a bow as well as permit a seamless integration with a bow to allow an archer to toggle between an on position and a standby position. For example, the laser distance meter assembly may include a a bow stabilizer mount. The laser distance meter may include a housing mount assembly configured to be secured onto the bow stabilizer mount. A display and an actuator switch (e.g., pressure switch, toggle switch, etc.) may connect to the laser distance meter by one or more communication lines or signals. The actuator switch may be disposed on the bow's handle. In this manner, the archer may simply squeeze the handle a bit harder to toggle the laser distance meter to an on position thereby emanating the lasers therefrom. In some instances, the display may be mounted above the static sight (e.g., pin sight) on the bow. The placement of each of these components may be inconsequential to the balancing of the bow. In fact, the laser distance meter may be configured to act as the stabilizer and the display may be proximate to the three-element sequence.

In certain embodiments, the laser distance assembly is mounted on a bow. The laser distance assembly may include a laser distance meter, a display, an actuator switch, and one or more communication lines (e.g., communication link, wireless signal, or wired line) configured to transmit information between the actuator switch, the display, and the laser distance meter. That is, as the actuator switch is operated, the switch may send a signal to the laser distance meter to switch between the standby position (e.g., low power or no power) to the on position (e.g., powered position). In turn, the on position of the laser distance meter may power a set of lasers disposed within the laser distance meter and a laser receiver may detect a particular frequency or signal. The processor may calculate the distance the laser travels by a reflection of the laser from a target back to the laser receiver, and then send the distance calculation to the display.

In certain embodiments, the laser distance meter includes an outer housing and an inner housing. The outer housing may be a substantially cylindrical tube, and the inner housing may complement the shape of the outer housing. In other instances, the outer housing and the inner housing may be another shape, such as a cube or another prism. As discussed herein, the outer housing may be configured to mount the laser distance meter to the bow. That is, the outer housing may include a front face and a mounting face. In this manner, the mounting face may be situated facing the bow and the front face may be on an opposed surface of the outer housing (e.g., facing away from the bow). The front face may allow the radiation, signal, and/or frequency from the set of lasers to emanate therefrom. The inner housing may, in some instances, complement the shape of the outer housing. In other instances, the inner housing may be another shape than the outer housing. The inner housing may be configured to store and secure electrical components therein (e.g., the lasers). In other embodiments, the inner housing and the outer housing may be integrated together to form at least one housing. In some instances, at least one housing may be more than two housings. For example, the laser distance meter may include a laser housing and a mount housing.

In certain embodiments, the laser distance meter includes a laser housing. That is, the laser housing may be configured to store a set of lasers and/or other electronics discussed therein. The set of lasers and/or a signal from the lasers may emanate from a lens disposed between the interior and the exterior of the laser housing. As used herein, the “set of lasers” may refer to the laser light, the laser emitters, and/or the laser receiver configured to detect a laser signal, frequency, and/or wavelength. An aperture may be disposed on the laser housing and the lens may be secured within the aperture. In some instances, the laser housing may include a first laser housing end and a second laser housing end. The first laser housing end may include the lens. The lens may be concave, convex, or some other shaped lens to help amplify the laser(s). In some instances, a mounting aperture may be disposed on the second laser housing end. In this manner, the mounting aperture may receive a mounting assembly configured to mount onto the mount housing and/or the bow. In other instances, the second laser housing end may be substantially flat coupled to a fastener or mounting assembly. In some instances, a magnet, hook, screw, or other mechanism may be operably disposed on the second laser housing end to attach to the mount housing and/or the bow.

In certain embodiments, the laser distance meter includes a mount housing. For example, the mount housing may be configured to selectively connect to the laser housing. The mount housing may include a mounting post and one or more detents disposed thereon to insert into the laser housing mounting aperture. That is, the detents may expand and contract to slide the mounting post within the mounting aperture. The detents may selectively lock the mount housing into place, parallel with the laser housing. In other embodiments, the mount housing and the laser housing may operably attach by another method, such as magnetism, adhesive, or fastener. In other instances, the mount housing and the laser housing may be permanently coupled together. In certain embodiments, the mount housing may include a first mount housing end and a second mount housing end. The mount post may be dispose don the first mount housing end, and a housing mount assembly may be disposed on the second mount housing end. The first mount housing end and the second mount housing end may be interchangeable. In other embodiments, the mount housing may include more than two mount housing ends.

In certain embodiments, the laser distance meter includes a housing mount assembly. For example, the housing mount assembly may include a ball joint, a ball joint socket, and fastener disposed on the ball joint. The housing mount assembly may be configured to operably attach (e.g., screw in, fasten, adhere to, secure) into a stabilizer mount on the bow. In some instances, the housing mount assembly may be disposed on the second mount housing end. In other instances, the housing mount assembly may be disposed on the laser housing or other outer housing of the laser distance meter. The ball joint socket may be secured within an aperture of the mount housing and configured to receive the ball joint. In some instances, the ball joint may operably rotate to point the laser distance meter in a particular direction away from the bow. In other instances, the housing mount assembly may not be a ball joint, but rather, a magnet, adhesive surface, fastener (e.g., screw, pin, hook), or other mechanism. On one end of the ball joint may be a fastener configured to secure the mount assembly partially within the stabilizer mount on the bow. That is, the stabilizer mount may be a threaded aperture and the fastener may be a screw that rotates and secures the laser distance meter onto the bow.

In certain embodiments, the laser distance meter includes a set of lasers. In some instances, the set of lasers may include a first laser, a second laser, and a laser receiver. At least one of the lasers may be visible. That is, at least one of the lasers may have a wavelength of 350-750 nanometers. Another laser may be invisible. That is, the laser may have a wavelength lower than 400 nanometers or above 700 nanometers. In this manner, the invisible laser may be detected by the laser receiver configured to detect and send a signal to a processor of a laser with a particular wavelength. Each of the lasers and laser receivers may be disposed within the laser housing. Further, each of the lasers may be configured to emanate through the lens disposed on the outer housing.

In certain embodiments, the laser distance meter assembly includes a communication line. For example, the communication line may be a wired connection (e.g., cord) or a wireless connection (e.g., Bluetooth, wifi, etc). In this manner, the cord may extend between the laser distance meter and an actuator switch. The actuator switch may be acted upon by a user (e.g., pressed, pushed, or otherwise actuated) to send a signal via the communication line to the laser distance meter and/or other devices (e.g., display, battery, etc.). In some instances, the communication line may have a first end and a second end. The actuator switch may be disposed at the first end, and an output connector may be disposed at a second end. In other instances, an output connector may be disposed at both ends of the communication line. That is, the connector may be operably connected to a laser distance meter and a display so that when the laser distance meter is switched to an on position discussed herein, the display powers on. In yet other instances, more than one communication line may be included in the laser distance meter assembly. The display may include one communication line configured to turn the display on separately from the laser distance meter. Further, the laser distance meter may include on communication line configured to turn on the laser distance meter separate from the display. Multiple actuator switches may be present to turn on devices included herein simultaneously or separately.

In certain embodiments, the laser distance meter assembly includes a display. The display may be a light emitting diode screen configured to relay various visual information and/or indicators. For example, the display may relay the distance between the front face of the laser distance meter and the target. The information may be communicated through a processor that converts data from the laser distance meter to comprehensible information. In some instances, the display may be a flat screen selectively located anywhere along the bow or its components. In other instances, the display may be disposed on a cubical housing that is mounted onto a static sight on the bow. The display housing may be any shape. The housing may be coupled to a bow sight via a fastener, hook and loop connection, adhesive or by some other method.

In certain embodiments, the laser distance meter assembly includes an on position and a standby position. That is, in the on position the actuator switch may send a signal via the communication line to a power source. The power source may then send current to the laser distance meter and/or other components (e.g., display). Then for as long as the actuator switch is held, the power may supply electricity to the electrical components. In other instances, the on position may stay in the on position when the actuator switch is activated. In yet other instances, the actuator switch may be a pressure switch, a circuit breaker switch, or some other type of switch. In certain embodiments, the standby position may be a low-power mode for the laser distance meter assembly. That is, the standby position may provide a low stream of current to the electrical components of the laser distance assembly (e.g., only power the display, only power the distance laser, or power any other combination of components). In some instances, the standby position may be operable to provide no electricity from the power source to the electrical components (e.g., an off position).

In certain embodiments, the laser distance meter includes one or more set screws. For example, in some instances the laser distance meter housing may include two set screws disposed between the interior and the exterior of the housing. In this manner, the screws may operably adjust the set of lasers within the laser housing between an azimuth and elevation angles. In some instances, the set screws may be disposed 90 degrees from one another about the outer housing. One screw may adjust the azimuth of the lasers and the other screw may adjust the elevation of the lasers. One end of the screw may be a handle, Philips head, knob, or other grippable surface. The other end of the screw may anchor into the inner housing to adjust the angle of the lasers. In other embodiments, the angle of the set of lasers may be adjusted by an electronic toggle switch disposed on the exterior of the laser distance meter. For example, the toggle switch may allow a user to designate the angle of the lasers by an up, down, left, and/or right push button. The one or more set screws may be another mechanism configured to adjust the set of lasers, such as rods, tracks, or knobs.

In certain embodiments, the laser distance meter includes a set of weight rings. That is, the outer housing may align several tracks (e.g., threads) configured to receive the weight rings. In this manner, the weight rings may anchor onto the outer housing providing a weighted housing for the laser distance meter. A benefit of the weight rings is the laser distance meter may act as a stabilizer for various users depending on their weight preference. In some instances, the weight rings may slide into place on the outer housing. In other instances, the weight rings may screw into place. The weights may secure onto the laser distance meter housing by a variety of other methods, such as by screw, lock, or snap. The laser distance meter may be configured to accept one weight rings. The laser distance meter may be configured to accept more than one ring.

In certain embodiments, the bow includes a proximate end, a distal end, a top end, and an opposed bottom end. The bow may be a recurve bow, a compound bow, a longbow, or a crossbow, among others. The bow may include an upper limb, a grip, an arrow rest, a lower limb, a wheel, and a string. In some instances, the bow may include a bow stabilizer mount on the distal end of the bow. The bow stabilizer mount may be a threaded aperture disposed near the grip of the bow, between the upper limb and the lower limb. In other instances, the bow stabilizer mount may be a hook, an adhesive, a snap, or another fastener configured to hold and/or support the weight of the laser distance meter.

In certain embodiments, the bow includes a static sight. The static sight may be a pin sight with a plurality of pins disposed therein. In some instances, the static sight may include a body (e.g., a circular tube), the plurality of pins disposed within the body, and a sight mount. The static sight may be mounted on the bow near the grip of the bow. That is, the static sight may be in the line of sight of the archer, above the grip. In some instances, each pin of the pin sight may be composed of translucent material. In this manner, when a light may be applied to an individual pin causing the entire pin to illuminate. In some instances, the static sight may operably illuminate an individual pin in the static sight. As discussed herein, the laser distance meter may detect a target at a distance, measure the distance to the target, and illuminate a particular pin aligned with the distance. The pins may be illuminated with a light emitting diode or other light fixture.

In certain embodiments, the laser distance meter assembly includes a wearable accessory and/or a wireless mobile device. For example, the laser distance meter may include a radio (as discussed herein) that transmits information calculated by the processor and sent via the radio to an application on the wireless accessory.

In certain embodiments, the laser distance meter assembly may be attached to a bow. For example, the laser distance meter may attach to a bow by a rigid mount, ball joint, or threaded male and female ends. In some instances, the laser distance meter may attach to a bow by a stabilizer. The stabilizer may be composed of several different configurations. The stabilizer may have a joint embedded in the bow. The stabilizer may have a hinge, ball, pivot, or gliding joint. A ball joint may attach to a multi-armed connection capable of pivoting in any direction. The multi-armed connection may then attach to the laser distance meter mount. For example, the laser distance meter may be selectively removable from the mount. In one embodiment, the laser distance meter may fasten, screw, or lock onto the mount. In other embodiments, the laser distance meter may be strapped by Velcro, elastic band, or other means to a user's hand.

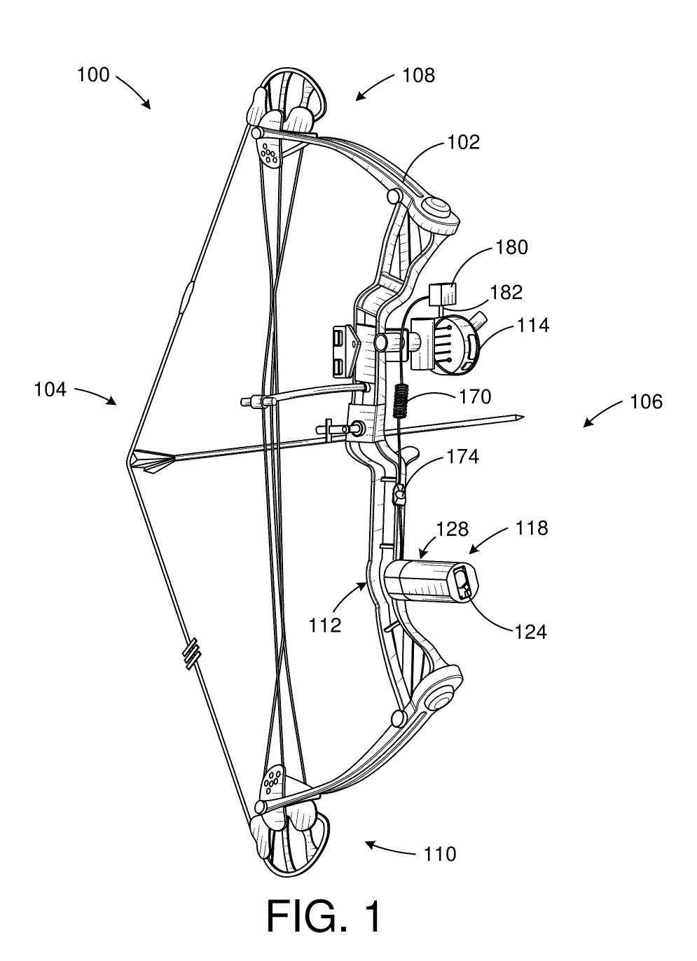

In some embodiments, as shown in FIG. 1, a laser distance meter assembly 100 includes a laser distance meter 118, a display 180, and a communication line 170 (e.g., a cord). The laser distance meter assembly 100 may attach to a bow 102. The bow 102 may include a proximate end 104, a distal end 106, a top end 108, and an opposed bottom end 110. On the distal end 106 of the bow, a bow stabilizer mount 112 may be disposed thereon. The components of the laser distance meter assembly 100 may be arranged in a variety of ways. In some instances, the laser distance meter 118 may be disposed on the bow 102 on the bow stabilizer mount 112. That is, the mounting face (not shown) may contact the bow stabilizer mount 112 and the front face 124 may project away from the bow 102. The at least one housing 128 of the laser distance meter 118 may be flipped so the front face 124 is disposed towards the bow 102. In other instances, the laser distance meter 118 may be secured anywhere along the bow 102 (e.g., the top end 108, the opposed bottom end 110, the proximate end 104, or the distal end 106).

In some embodiments, the laser distance meter assembly 100 includes an actuator switch 174 along the communication line 170. The actuator switch 174 may secure to the grip of the bow 102. In other instances, the actuator switch 174 may secure to another surface along the bow 102. The communication line 170 may line the bow 102 by fasteners, adhesive, or other attachment mechanism. In this manner, the communication line 170 may extend towards the top end 108 of the bow 108. At one end of the communication line 170 may be the laser distance meter 118, and at the other end of the communication line 170 may be a display 180.

In some embodiments, the laser distance meter assembly 100 may include a display 180 secured to a static sight 114 via a display mount 182. In some instances, the display mount 182 may be a post coupled to the display 180 and the static sight 114. In other instances, the display mount 182 may be an adhesive, fastener, or other mechanism configured to secure the display to the static sight. The display 180 may include a cubical housing configured to emit light diodes towards the proximate end 104 of the bow 102. In this manner, as a user operates the actuator switch 174, the display 180 may light up for the user with relevant information relayed from the laser distance meter 118.

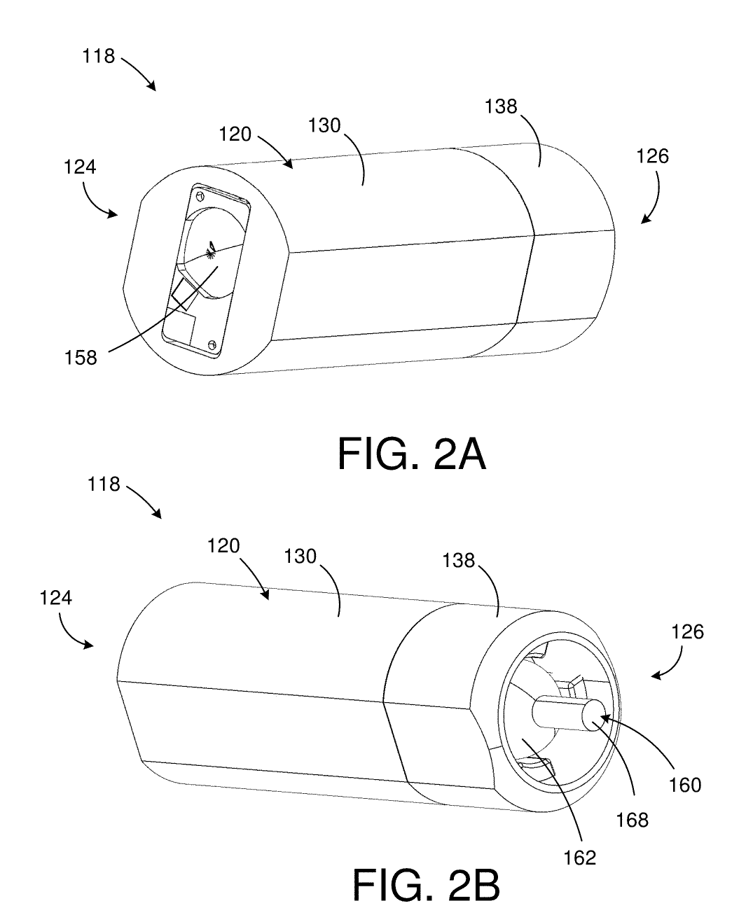

In some embodiments, as shown in FIG. 2A-2B, the laser distance meter 118 includes at least one housing. In some instances, the laser distance meter 118 includes a front face 124 and a mounting face 126. Each face may be disposed on opposite ends of the laser distance meter 118 outer housing 120. The laser distance meter 118 may include a laser housing 130 and a mount housing 138. The laser housing 130 may be coupled to the mount housing 138. In this manner, the laser housing 130 may secure the lasers therein and the mount housing may attach to the laser housing 130 to secure the laser housing 130 to a bow 102. A lens 158 may be disposed on the front face 124 and configured to allow lasers to emanate therefrom. A house mount assembly 160 may be disposed on the mounting face 126. Within the house mount assembly 160, a ball joint 162 and a fastener 168 may be disposed therein. In this manner, the house mount assembly 160 may be configured to secure onto a bow stabilizer mount (not shown). In some instances, the fastener may be a screw. In other instances, the fastener 168 may be a pin, hook, or some other anchor for the laser distance meter 118.

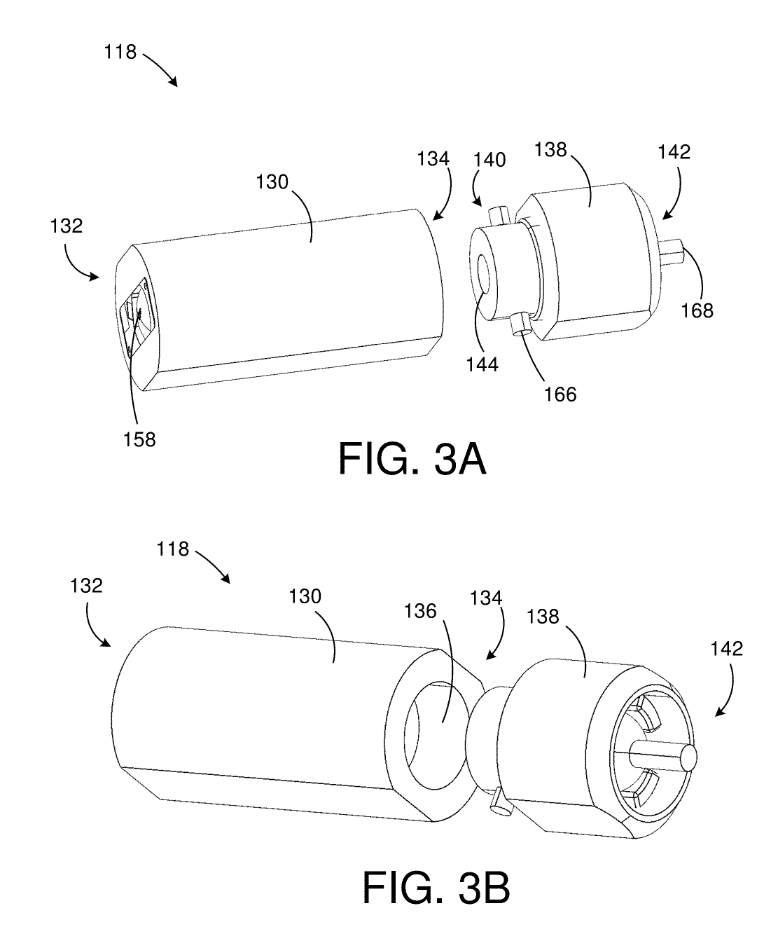

In some embodiments, as shown in FIGS. 3A-3B, the laser distance meter 118 may be configured to separate into multiple components. For example, the laser housing 130 may separate from the mount housing 138. The laser housing 130 may include a first laser housing end 132 and a second laser housing end 134. On the second laser housing end 134 may include a mount aperture 136. The mount housing 138 may include a first mount housing end 140 and a second mount housing end 142. In some instances, the first mount housing end 140 may include a mounting post 144 and one or more detents 166. The mount aperture 136 disposed on the laser housing 130 may be configured to receive the mounting post 144 and/or the one or more detents 166. In some instances, the one or more detents 166 may be configured to retract via a button or pulling force. Once the mount housing 138 is secured to the laser housing 130, the laser distance meter 118 may be secured to the bow. That is, the second mount housing end 142 may include the housing mount assembly. The housing mount assembly may be disposed on any one of the surfaces on the laser distance meter 118.

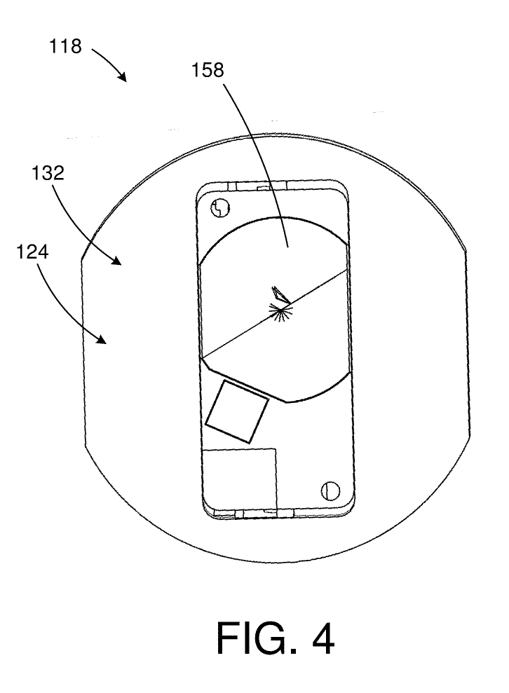

In some embodiments, as shown in FIG. 4, the laser distance meter 118 may include a lens 158. For example, the lens 158 may be disposed on the front face 124 and/or the first laser housing end 132. In some instances, the front face 124 and the first laser housing end 132 may be the same surface. In other instances, the front face 124 and the first laser housing end 132 may be separate sides of the laser distance meter 118. The lens 158 may be circular, square, or some other shape.

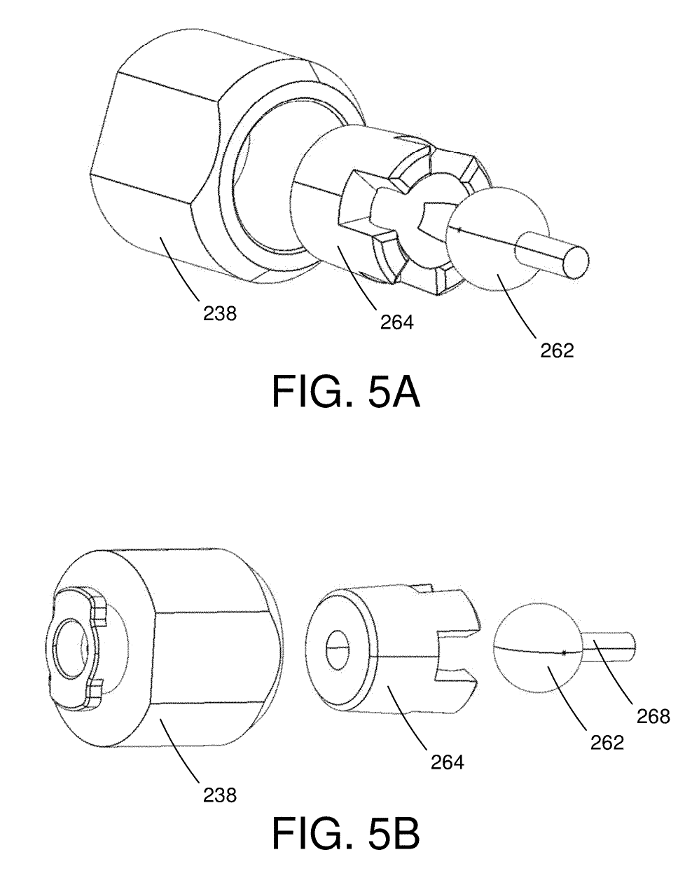

In some embodiments, as shown in FIG. 5A-5B, the mount housing 238 may be configured to store and secure a ball joint socket 264. In this manner, the ball joint socket 264 may selectively hold in place the ball joint 262 and fastener 268. In other embodiments, the mount housing may be a single, continuous piece configured to secure the laser distance meter 118 to the bow (not shown). That is, the mount housing may be a complementary shape to the laser housing and include one or more fasteners to secure the laser distance meter to the bow.

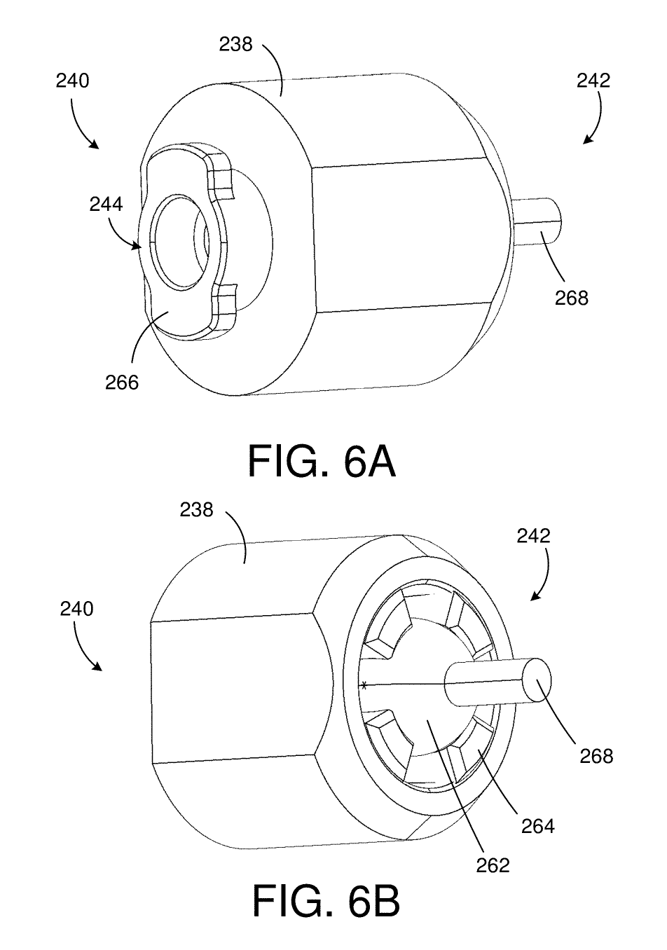

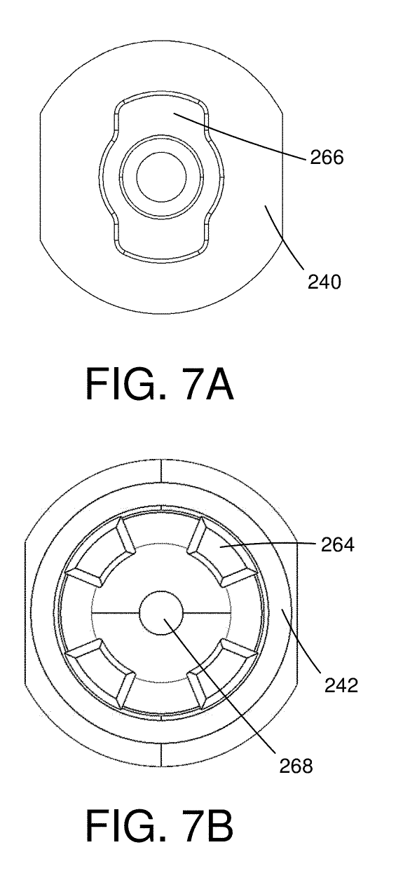

In some embodiments, as shown in FIGS. 6A-7B, the mount housing 238 may include a first mount housing end 240 and a second mount housing end 242. On the first mount housing end 240, a mount post 244 may extend therefrom and configured to secure within the laser housing. In some instances, one or more detents 266 may be a flat leaf shape disposed around the mount post 244. In this manner, the laser housing may include a complementary shaped aperture to the mount post 244. As the mount post 244 is inserted into the laser housing, the mount housing 238 may rotate to secure the mount post 244 within the laser housing. Opposite from the mount post 244 on the mount housing may be a ball socket 262, a ball joint socket 264, and/or a fastener 268.

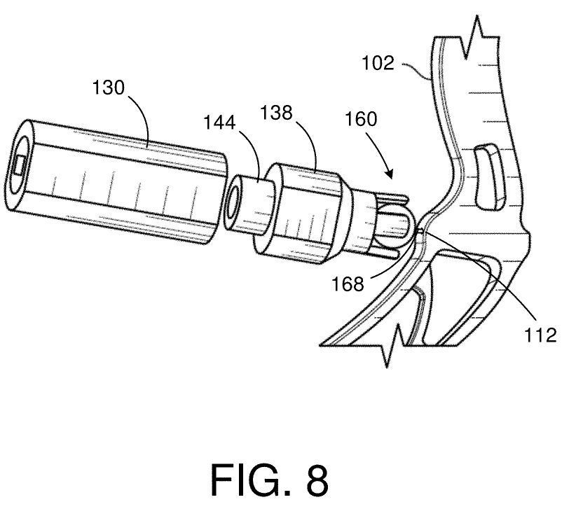

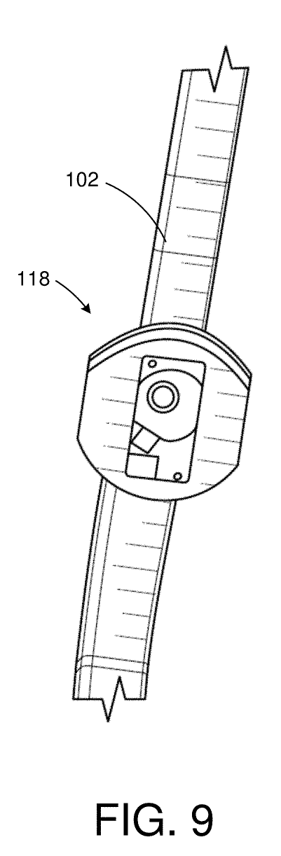

As shown in FIG. 8, the exploded view of the laser housing 130, the mount housing 138, and the mounting post 144. Further, as shown in FIG. 8, the laser distance meter may be secured onto the housing mount assembly. In some instances, the fastener 168 may be secured within the bow stabilizer mount 112. From the fastener 168, the housing mount assembly may secure onto the ball joint. FIG. 9 depicts a distal view of the bow 102 and the laser distance meter 118 disposed thereon.

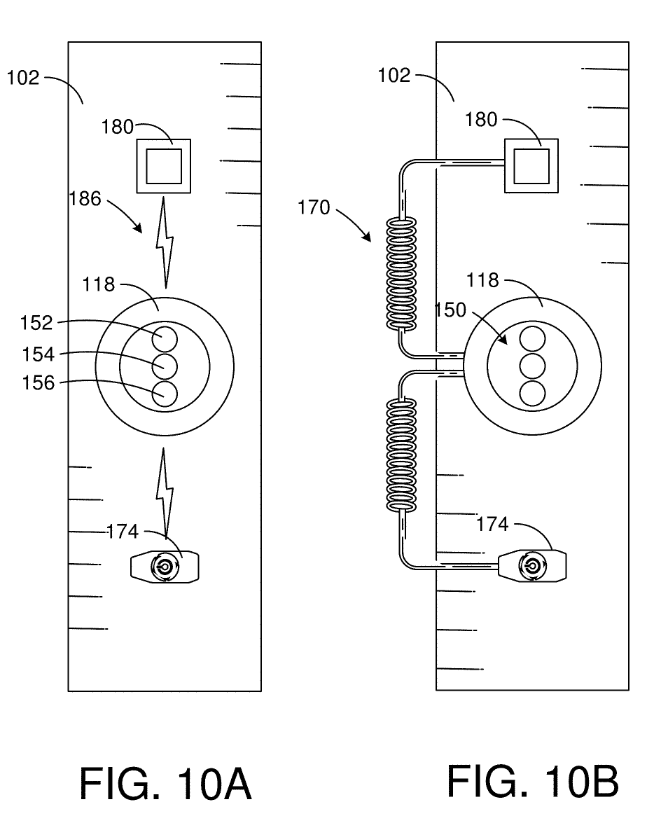

In some embodiments, as shown in FIGS. 10A-10B, the laser distance meter assembly includes a communication line 170 configured to transmit information between the actuator switch 174, the laser distance meter 118, and the display 180. FIGS. 10A-10B depict the schematic view of the laser distance meter and one embodiment of how a first laser 152, a second laser 154, and a laser receiver 156 are arranged. In other embodiments, the first laser, the second laser, and the laser receiver may be arranged in another order. Each of the components may be disposed on or near the bow 102. In some instances, the communication line 170 may be a solid cord. In other instances, as shown in FIG. 10B, the communication line may be a wireless connection transmission 186. That is, the actuator switch 174, the laser distance meter 118, and the display 180 may each have a radio disposed therein to receive signals from other components.

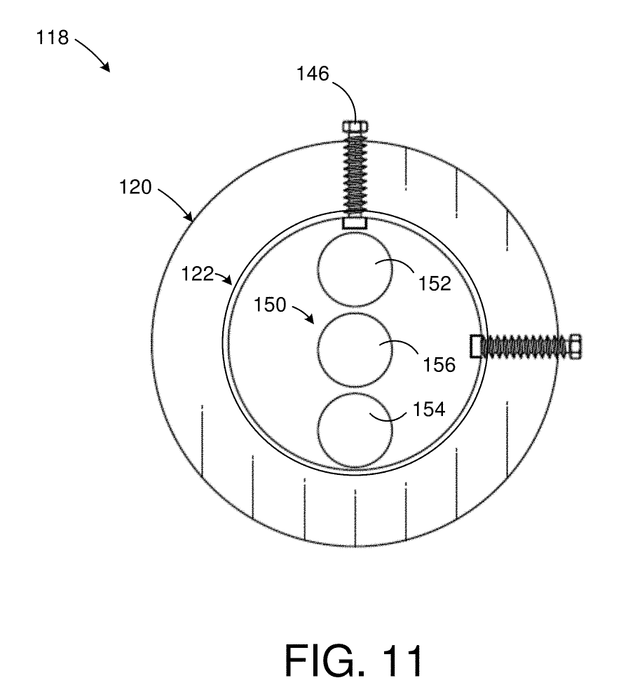

In some embodiments, as shown in FIG. 11, the laser distance meter 118 may include an outer housing 120 and an inner housing 122. In some instances, set screws 146 may extend between the outer housing 120 and the inner housing 122. In this manner, the set screws 146 may rotate to adjust the azimuth and elevation of the inner housing 122. Within the inner housing 122 may be a set of lasers 150. That is, a first laser 152, a second laser 154, and a laser receiver 156 may be secured within the inner housing 122. When the set screws 146 are actuated, the set of lasers 150 may adjust accordingly. In other instances, outer housing 120 may include a hollow interior that the inner housing 122 is disposed therein.

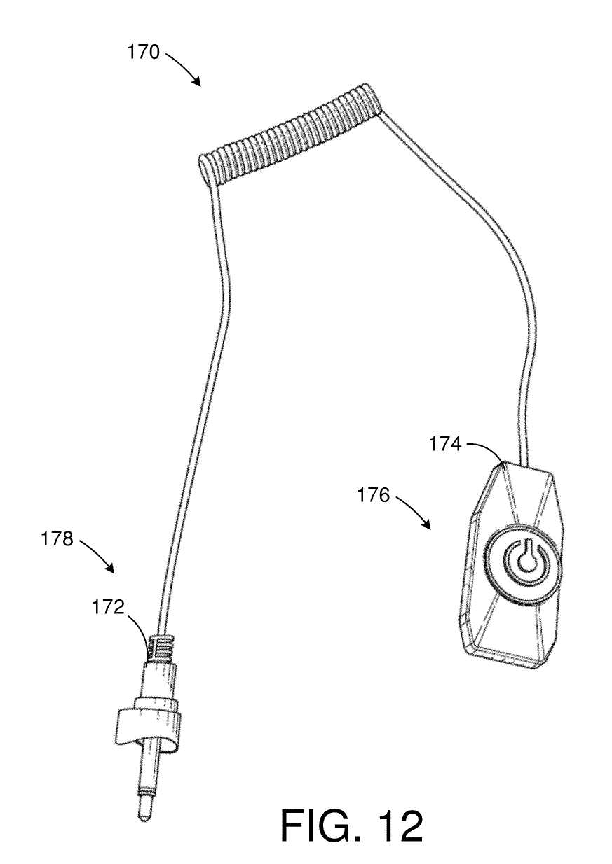

One embodiments of the communication line 170 is depicted by FIG. 12. In some instances, the communication line 170 may include a first end 176 and a second end 178. On the first end 176, the communication line 170 may include a actuator switch 174. In some instances, the actuator switch 174 may be a pressure switch. On the second end 178, the communication line 170 may include a cord output connector 172.

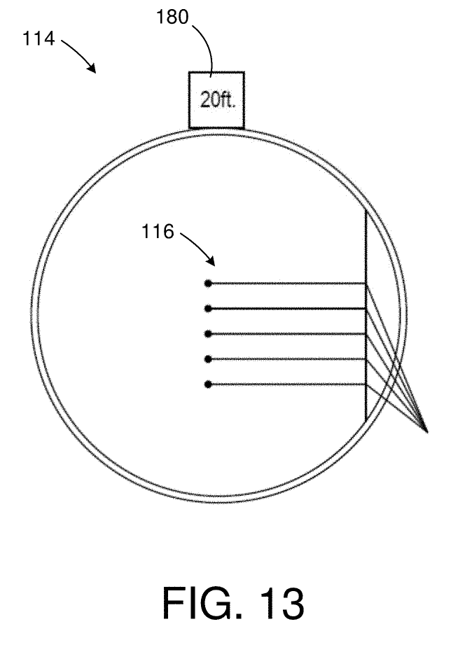

In some embodiments, as shown in FIG. 13, the laser distance meter assembly (not shown) includes a static sight 114. In some instances, the display 180 may couple to the static sight 114. The static sight 114 may include sight pins 116. The sight pins 116 may be translucent and configured to light up to correspond to a distance shown on the display 180.

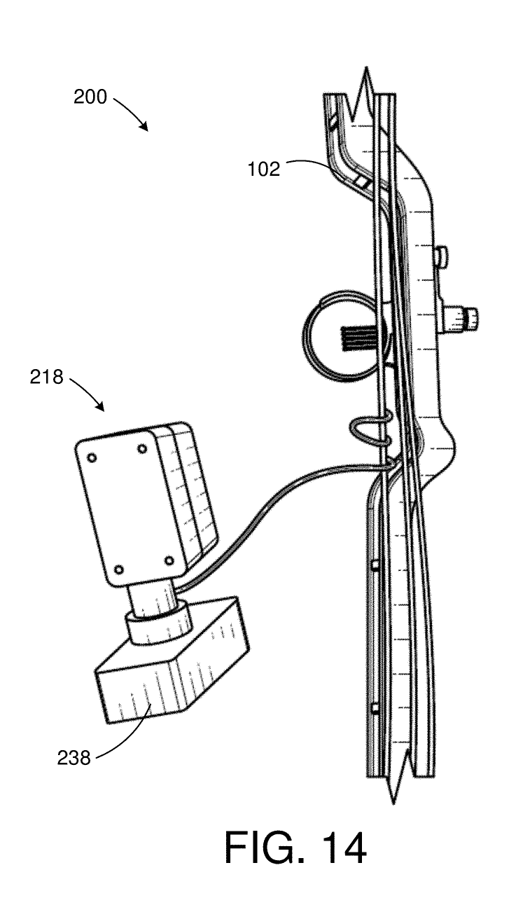

In some embodiments, as shown in FIG. 14, a laser distance meter assembly 200 may include a laser distance meter 218 and a mount housing 238 configured to be mounted onto a user. For example, the mount housing 238 may be configured to wrap around a user's hand. In other instances, the mount housing 238 may be configured to attach to another complementary surface.

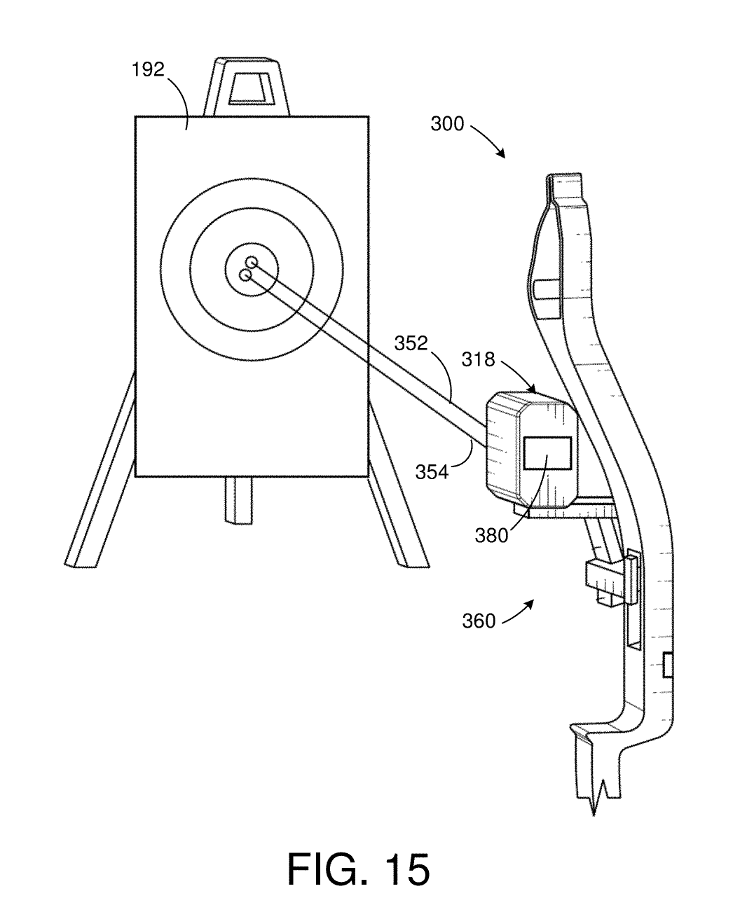

In some embodiments, as shown in FIG. 15, the laser distance meter assembly 300 may include a laser distance meter 318 configured to emanate a first laser 352 and a second laser 354. The laser distance meter 318 may be secured to a bow via a housing mount assembly 360. In some instances, the housing mount assembly 360 may be a plurality of struts. The laser distance meter 318 may include a cubical shaped housing. In some instances, the laser distance meter 318 may be operated to emanate the set of lasers towards a target 192.

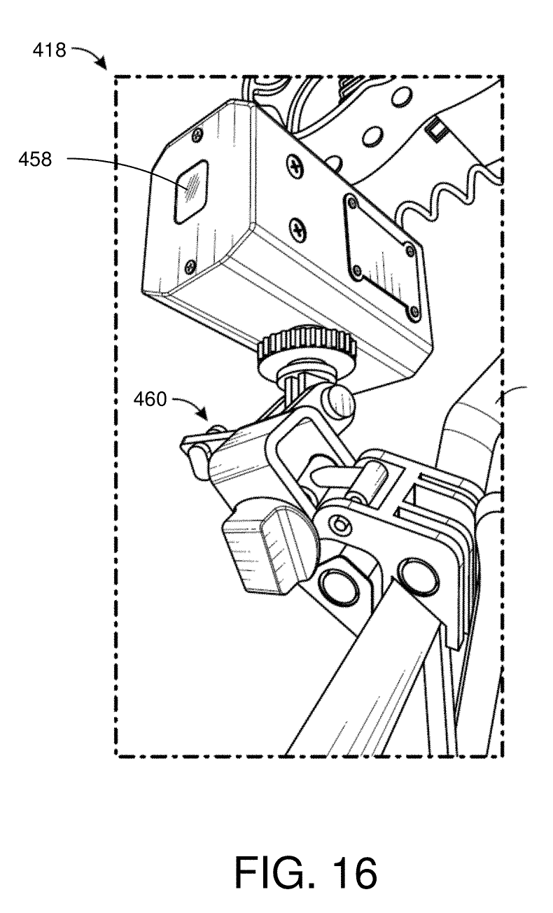

In some embodiments, as shown in FIG. 16, the laser distance meter 318 may be disposed on a housing mount assembly 460. In some instances, the housing mount assembly 460 may be an adjustable set of anchors configured to set the laser distance meter 318.

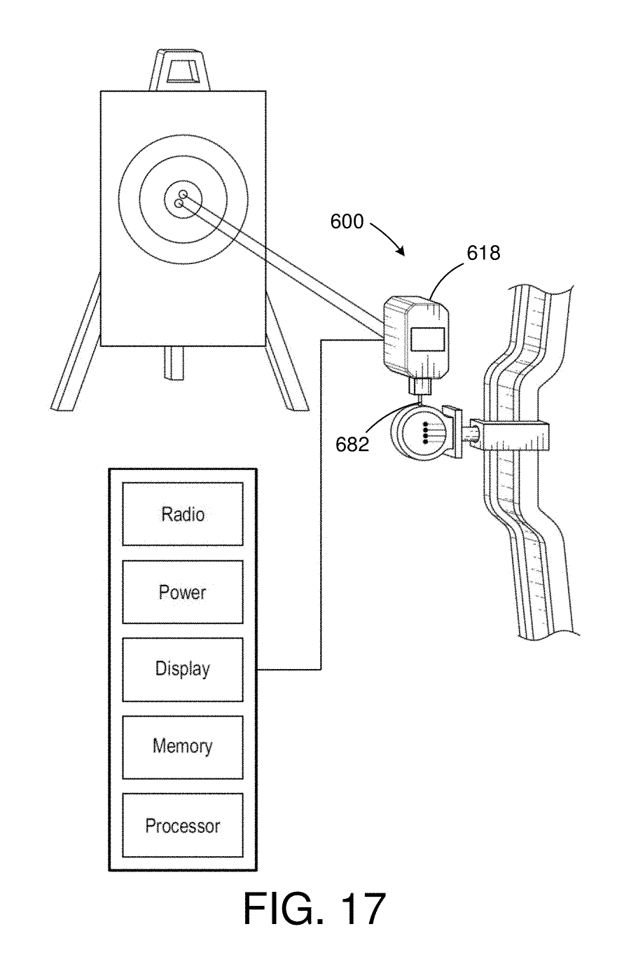

In some embodiments, as shown in FIG. 17, the laser distance meter assembly 600 may include a laser distance meter 618. The laser distance meter 618 may be secured to a static sight on a bow via a display mount 682. The laser distance meter 618 may include a radio, a power source, a display, a memory, and a processor. Each of the components may operate together to emanate a set of lasers to calculate and return a distance on the display.

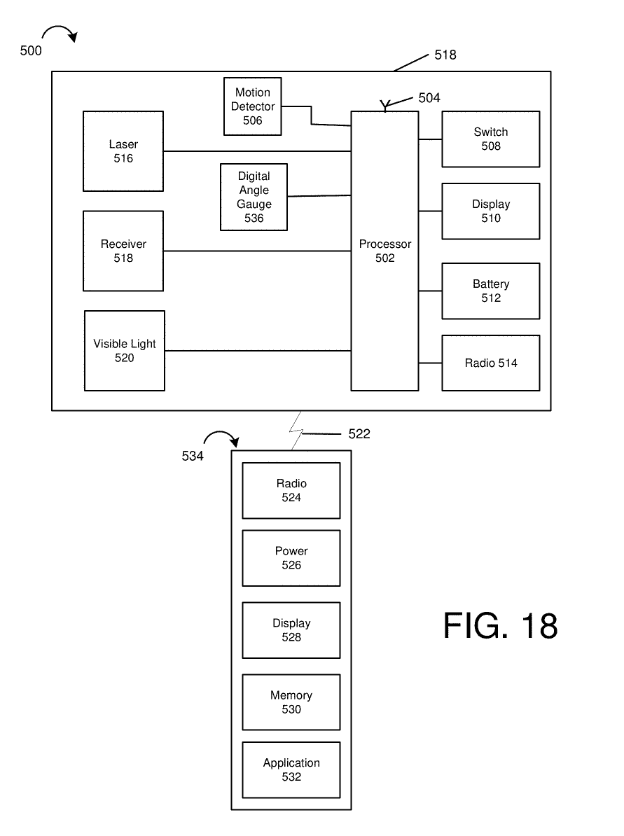

In some embodiments, the laser distance meter 500 of FIG. 18 may be capable of wireless transmission 522 to a wireless mobile device 534. The transmission 522 may be sent via the wireless radio 514. The transmission 522 may contain data from the processor 502. The data sent via transmission 522 may include the distance calculated to a target. The transmission 522 may be received by a wireless mobile device 534. In some embodiments, the wireless mobile device 534 may be a smartphone, tablet, wearable or any device with a wireless radio 524. The wireless mobile device 534 may comprise of a radio 524, power source 526, display 528, memory 530, and an application 532 stored in the memory 530. The wireless mobile device 534 receives the data and generates a user interface. Other data the user interface may show is ambient temperature surrounding the laser distance meter, the angle of bow, humidity, and wind. Each set of data may be included in the transmission 522, and the data may also be stored locally within the memory 530 or in the cloud in association with a user account.

The laser distance meter assembly 500 may include a laser distance meter 518. The laser distance meter may be capable of processing distance data as well as communicate this and other data. The laser distance meter, in one embodiment, may comprise a laser emitter 516 and a laser receiver 518. The laser emitter 516 may generate a light capable of projecting 80 or more yards from the device. The light produced by the laser emitter 516 may hit a target and reflect back to the laser distance meter. In some embodiments, a laser receiver 518 detects the laser light. The processor 502 within the laser distance meter may calculate the time between when the laser emitter 516 is actuated and when the reflected light is captured by the laser receiver 518. The determined time of flight can be used to determine the distance to the item causing the reflected light. In some embodiments, the laser distance meter contains a visible light emitter 520. The visible light emitter 520 may emit a beam of visible light that is substantially parallel to the invisible light beam emitted by the laser emitter 516. A benefit to the visible light emitter 520 is a user may have an easier time determining where the laser emitter 516 is specifically pointing because the light emitter may produce a brighter laser at a different frequency than the laser emitter for measuring the distance to a target. All of the laser distance meter may receive power from an internal battery 512.

In some embodiments, the laser distance meter may have a display 510. The display 510 may use light emitting diodes (LED) or other display devices to display the information transmitted via electrical circuits from the processor 502. The laser distance meter may also only turn the battery 512 from hibernate mode when the switch 508 is activated. Hibernate mode could be a mode that has the laser distance meter in a low power state using a minimal amount of power draw from the batter 512. This could help the battery life of the battery 512. The switch 508 may be a pressure switch. A pressure switch works by having two contacts set in an open position. The contacts could stay in an open position by a spring or other mechanism. When force is applied to force the contacts towards one another the circuit closes and providing a connection between electrical components. In one embodiment, the laser distance meter 500 contains a motion detector 506. The motion detection 506 may work with the processor 502 to transition the laser distance meter to a low power mode or off completely due to lack of motion over a period of time. The motion detection 506 may include an accelerometer. Accelerometers use the piezoelectric effect to determine when accelerative forces act on the device. The accelerometer generates a voltage whenever a moving force works on the motion detection system, then sends that voltage (i.e., signaling that movement has occurred) to the processor.

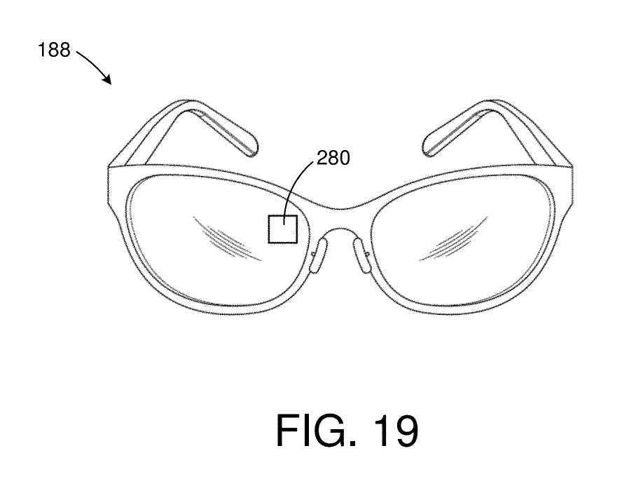

In some embodiments, as shown in FIG. 19, the laser distance meter assembly may include a wearable accessory 188 (e.g., glasses, hat, glove, etc.). The wearable accessory 188 may be configured to communicate with the laser distance meter (not shown). That is, the wearable accessory 188 may be coupled to a display 280 that communicates information to a user.

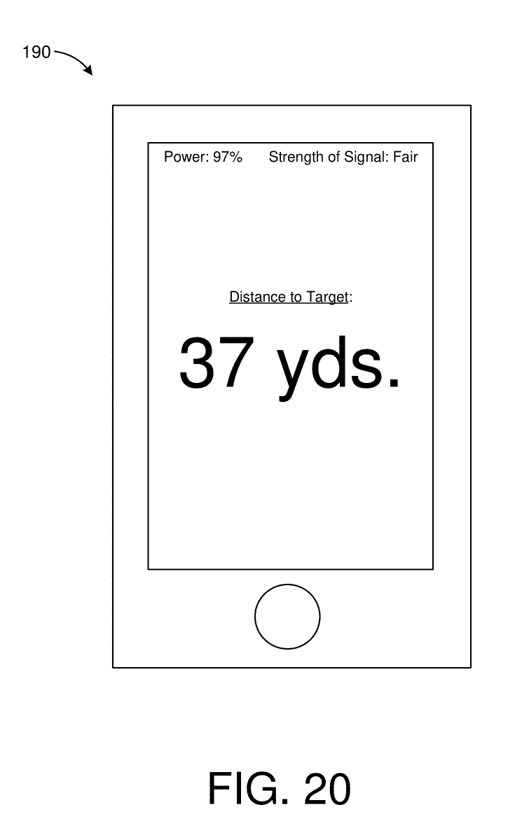

In some embodiments, as shown in FIG. 20, the laser distance meter assembly may include a wireless mobile device 190.

### Other Embodiments

The laser distance meter may comprise a housing, and the house may include a computer processor, a laser emitter, a laser receiver, at least one switch, a display, and a power source. The laser distance meter switch may be a pressure switch. In some embodiments, the pressure switch is attached to the power source. When the pressure switch is actuated to an on position, the power source may send power via internal circuitry to actuate the range finding function of the laser distance meter, resulting in a distance to the target being displayed by the display.

The laser emitter may project a light amplified by stimulated emission of radiation to a point on a target, where at least a portion of the radiation is reflected back towards the laser distance meter. The laser emitter may be rated at five milliwatts, which power may be provided by the power source. The reflection of the light can then be received by the laser receiver. The laser receiver can detect the resonance of the received laser light, and can send a signal indicative of such to the processor. The signal can then be used by the processor to determine a distance of the target from the laser distance meter. The distance value can then be presented by the display. In some instances, the laser distance meter may include a visible laser emitter that projects in a parallel path from the housing with respect to the laser emitter.

Described below are other example embodiments of a laser distance meter assembly (as well as individual components of the laser distance meter assembly) for attachment to a bow. Methods of installing and using the laser distance meter assembly on the bow are also disclosed. A laser distance meter may be used by an archer when trying to determine if the bow has the appropriate strength to fire a projectile a calculated distance. If the archer determines a distance to a target is too far for the bow, the archer may want to move closer to the target. However, the distance may be measured incorrectly if the user's eye, the laser, and the target are not aligned properly.

In one embodiment, a laser distance meter in accordance with the present disclosure may be affixed to a bow for use recreationally or for sport (e.g., competition or hunting). The bow may be a conventional bow. For example, the bow may be a recurve bow, a compound bow, a longbow, or a crossbow, among others. Any bow may be used. The laser distance meter may be configured to attach to the bow at, for example, the stabilizer, the grip, or the limbs.

The laser distance meter may attach to the bow by a mount assembly. In some embodiments, the mount assembly is series of rigid connections. For example, the mount assembly comprises a first bracket extending from the bow, a second bracket may attach to the first bracket, and a third bracket may be attached to the second bracket as well as to the laser distance meter, such as by its housing. The housing may attach to the third bracket by a fastener, such as Velcro, or any suitable means.

In some embodiments, the laser distance meter may comprise a laser emitter that may generate a first laser beam, a second laser emitter that may generate a second laser beam, a display, and a housing. The laser distance meter may include a laser receiver that captures the light from the laser through divergence or reflection. That is, light reflected off the target is detected by the laser receiver. The laser receiver may include a photosensor, which converts the frequency of light into current. Discussed infra., the photosensor may relay the current to the processor, and the processor determines a time between actuating the laser emitter and the photosensor generating a current. The housing may also contain a radio transceiver that transmits information to a wireless mobile device. The transmission may be by Bluetooth, WiFi, WiFi Direct, near-field communications (NFC), or another suitable wireless protocol.

The wireless mobile device may be a smartphone, tablet, wearable device, laptop, or other device. The mobile device may communicate data with the laser distance meter such as distance data, the power of an internal battery data, the strength of the wireless signal, and various other data. The data received by the mobile device may display for a user on a liquid-crystal display (LCD) screen. The wireless mobile device may comprise a radio, a source of power, a display, memory, and a processor. Each piece of data may be displayed by an application executed by an example wireless mobile device, which may be an embodiment of the wireless mobile device, that received the data from the laser distance meter. The wireless signal generated by the laser distance meter may be received by the radio of the wireless mobile device, and then sent via electric circuits to a processor. The processor transmits the information to memory and/or the display. The display may present visual information to a user. For example, the display may show the distance from the laser distance meter to a target.

A second laser beam may be generated by the laser distance meter, which may be aligned in parallel with a first laser emitter to help alleviate the need for alignment of a user's eye by providing light in the visible frequency spectrum. The laser(s) described herein may emanate from a laser emitter disposed within the laser distance meter. In one embodiment, the laser distance meter may attach to a mounting assembly held in place by brackets on a bow. The mounting assembly may comprise a first bracket, a second bracket, and a third bracket. In other embodiments, the laser distance meter may attach to the bow by other means (e.g., Velcro strap) to the mounting assembly or directly to the bow. The laser distance meter may attach by commercially available mounts as well. The laser distance meter may attach so that the first laser beam (possibly used for distance measurements) and the second laser beam (possibly used for visual light) point in the direction of a target. The lasers may center at a particular distance, or the lasers may run parallel to one another. Once the laser distance meter is powered on, a display may pivot towards the user to provide useful information (i.e., distance, battery life, other connected devices, etc.).

In another embodiment, the laser distance meter assembly may have several removable components. For example, shows a first housing attached to a second housing. A first housing may be removed from the second housing. The first housing may have a laser end and a threaded female end opposite to the laser end. In some embodiments, the first housing may attach to a second housing or attach to a bow by a bracket, by adhesive, by a strap, or another binding hardware. The first housing and the second housing may be made of either a metal, an alloy, a plastic composite, a combination thereof, or other material. The first housing may be different shapes such as cylindrical, spherical, or other prism type shape. A benefit to a cylindrical laser distance meter with a stabilizer is added stability while a user draws the bow. Furthermore, a stabilizer attached cylindrical housing may not restrict or limit an archer's field of view.

The first housing may contain other devices besides a plurality of laser emitters. A transmitter, a radio, and a processor may all be within in the first housing. The information transmitted by the transmitter may be distance information calculated by the processor, wherein a transmitter, radio, and processor are interconnected by electronic wiring all contained within the first housing. The processor may calculate the distance to the target once light reflected off the target is detected by the laser receiver. The laser receiver may include a photosensor, which converts the frequency of light into current. Discussed infra., the photosensor may relay the current to the processor, and the processor determines a time between actuating the laser emitter and the photosensor generating a current. The processor may also determine and send information to the visual display. A transmitter may also be located inside the first housing. The transmitter may communicate data through wireless transmission to a mobile device.

The laser distance meter may have a second housing. The second housing may be cylindrical, spherical, or other prism type shape. The second housing may have a threaded front end for connecting to the threaded female end of the first housing. The second housing may also have an attachment post opposite the threaded front end for attachment to a mount on the bow, to a stabilizer on the bow, or to the bow itself. In some embodiments, the second housing may attach to the first housing or the bow by a bracket, by adhesive, by a strap, or another binding hardware. The attachment post may be threaded, snapped, or fastened onto a port located on the bow. For example, the attachment post may be threaded so that it may be securely screwed into the bow.

The laser distance meter may have a power source. The power source may be within the first or second housing. In some embodiments, the power source may be external to the housing. For example, the power source may be a battery that connects to the second housing. The power source may be a 1.5-volt battery, among others. The power source may be more or less voltage and amperage depending on the power necessary for the lasers and other electronics. The current could range between 1 to 50 milliamperes. The current could be above the specified range depending on the intensity of the laser emitter. The power source may enable a variety of functions on the laser distance meter. For example, the laser distance meter may have one laser or a plurality of laser emitters to emit a laser. The power source may connect to the plurality of laser emitters. At least one switch may control the laser distance meter processor, and in turn, turn on the plurality of laser emitters. In a similar embodiment, the power source may connect to a visual display. The switch may also toggle the processor to control the visual display. The switch may include toggle, pushbutton, limit, proximity, pressure, temperature or other types of switches. A pressure switch could, for example, be composed of a variable resistor. The pressure switch may be located within a pad on the bow. In some embodiments, the pressure switch may be located on the housing. The advantage of including variable adjusting switches, such as a pressure switch, is to allow for the variable adjustment of laser intensity without unbalancing a drawn bow. The laser distance meter's power source may be controlled by the processor receiving a signal from a remote actuator connected by a wire or connected wirelessly. The remote switch may be a pressure sensing pedal allowing a user's foot to control the intensity of the lasers.

The laser distance meter may draw power from a power source within the second housing or by another connection. Other connections for the power source could include a wired connection. The wired connection may be a series of copper wires arranged in a circuit to provide a positive and negative connection for the electronics. A power source within the second housing could be rechargeable batteries or derive power from replaceable batteries. The power source within the second housing could have a positive current and negative current connection with the first housing.

The laser could be a single laser or be an emission of one of a plurality of laser emitters. For example, a first laser beam aligns with a second laser beam. Each laser beam may project from a single laser emitter or more than one laser or visible light emitters. The first laser beam could be used for measuring the distance of a target. The first laser beam may be faint or invisible. The second laser beam may be a visible laser that could be momentarily or permanently enabled for a user to locate a point of reference for the first laser beam. The second laser beam may emit a frequency of light on the visible light spectrum. The first laser beam and the second laser beam could be enabled by a switch. The laser distance meter may have a separate switch to control the intensity, size, or color of the lasers. For example, a switch could control the intensity of a visible or distance meter laser by increasing the voltage output of the power source to the laser emitters. The advantage of increasing or decreasing intensity of the lasers is for power efficiency as well as a possible increase in accuracy for distance measurement in inclement weather. The lower the intensity the laser, the less power the laser emitter would consume from the battery. In some embodiments, the visible laser emitters, may include green, yellow, red, blue, or another color laser. A benefit of different colored visual lasers is to contrast with the present environment or weather appropriately. In some embodiments, the plurality of laser emitters may create beam divergence for measurement. The first housing may also contain reflex mirrors to capture the laser reflecting off a target, lenses, and a processor for measuring the plurality of laser beam divergence. The first laser beam and second laser beam, in one instance, could be parallel or, in another instance, could intersect at a specific distance. The distances the plurality of laser emitters are set to measure could cover a range at or above yards. The laser emitters, both visible and invisible for distance measuring, could cover the same distances. The laser receiver could be tuned to receive the frequency of the invisible laser emitter for distance measuring. The first laser's divergence may be measured by the laser receiver of the laser distance meter, and the processor may use that information to calculate the distance.

In other embodiments, the display of the laser distance meter may provide to the user several types of information. The display may work by a series of light emitting diodes illuminating in a set pattern to show the information. The display may provide information such as the distance to the target or the angle from level of the bow. The angle from level of the bow may be measured by a digital angle gauge contained within the housing of the laser distance meter. The display may be attached to the first housing and receive information from a wired connection. The display, in one embodiment, detaches from the house and attach to another surface using Velcro, adhesive, a clip, or another type of attachment apparatus. The display may be mounted to pivot on an axis at the point of attachment. A transmitter may send information from the processor to another device, such as a mobile phone, watch, or another device. A digital light sensor may connect to the display to detect sunlight. The digital light sensor may also connect to the processor to alert for a change in brightness or contrast of the display. In some embodiments, the display may adjust screen color or the visible laser color. The display could also receive information from a processor to display information received by an antenna connected to the processor via a wireless or Bluetooth connection.

In some embodiments, the laser distance meter may have a circular lens. At least one laser emitter and laser receiver may be located behind the circular lens. The laser receiver within the laser distance meter housing may be behind the circular lens. Other components such as the visible laser emitter could also be housed behind the circular lens. The laser distance meter could be mounted perpendicular from the bow to be substantially parallel to a drawn arrow.

In one embodiment, the laser distance meter is mounted to a ball joint. A benefit to a ball joint connection is the laser distance meter could swivel in varying angles to a target. For example, the ball joint would allow the laser distance meter to be angled perpendicular to the bow as well as angled in many other directions. The laser distance meter may comprise of a ball joint attachment, a first housing, and a second housing. The ball joint attachment may latch on to the ball joint. The second housing may be permanently coupled to the ball joint attachment, and the first housing may be selectively coupled to the second housing. Within each housing, a variety of electrical components may reside such as at least one laser emitter, a power source, a laser receiver, a processor, and a radio, among others. Other components could include a pressure switch attached to the housing as well as a display unit.

In some embodiments, the laser distance meter may attach to a bow by other means than previously discussed. In some instances, the laser distance meter may attach to a user's hand by, for example, a binding. The binding may have a hook and loop attachment mechanism for each strap to wrap around the laser distance meter as well as an archer's hand. In one embodiment, the laser distance meter may attach to a bow by swiveling brackets. The swivel brackets may be interconnected individual brackets swivel about a cylindrical bolt that binds each bracket to the next.

In one embodiment, the laser distance meter has multiple lenses. Each lens may cover a different component contained within the housing. For example, one lens may cover the laser emitter, one lens may cover the laser receiver, and one lens may cover the visible light emitter.

### Example Embodiments

Example 1 may include a laser distance meter assembly to be mounted on a bow. The laser distance meter assembly may include a laser distance meter. The laser distance meter may include at least one housing with a front face and a mounting face. The laser distance meter may include a set of lasers disposed to emanate from the front face where at least one laser is visible. The laser distance meter may also include a housing mount assembly configured to secure the laser distance meter to a bow stabilizer mount disposed on the bow. The laser distance meter assembly may include a display removable mounted onto the bow. The laser distance meter assembly may include at least one communication line configured to transmit information between the actuator switch and the laser distance meter.

Example 2 may include the laser distance meter assembly of example 1 where the display is mounted via a display mount to a static secured to the bow.

Example 3 may include the laser distance meter assembly of example 1. The laser distance meter may include an outer housing and an inner housing disposed within the outer housing. The outer housing may include a front face and a mounting face disposed on opposing surfaces of the housing. A lens may be disposed on the front face and the housing mount assembly may be disposed on the mounting face.

Example 4 may include the laser distance meter assembly of example 3. The at least one housing may include a laser housing with a first laser housing end and a second laser housing end. The at least one housing may include a mount housing with a first mount housing end and a second mount housing end. The at least one housing may include a mounting aperture disposed on the second laser housing end and a mounting post disposed on the first mount housing end. The mounting post may be configured to secure within the mounting aperture via one or more detents protruding from the mounting post.

Example 5 may include the laser distance meter assembly of example 4 where the housing mount assembly is disposed on the second mount housing end. The housing mount assembly includes a ball joint, a socket coupled to the second mount housing configured to receive the ball joint, and a fastener disposed on the ball joint. The fastener may selectively attach to the bow stabilizer mount.

Example 6 may include the laser distance meter assembly of example 5 where the laser housing includes a first laser disposed within the laser housing. The laser housing may also include a laser receiver configured to detect the first laser, and a second laser. The second laser may have a wavelength of 350 to 750 nanometers.

Example 7 may include the laser distance meter assembly of example 1 where the at least one communication line includes at least one cord with a first end a second end. The at least one communication line includes a cord output connector coupled to the first end and the cord output connection may operably connect to the laser distance meter. The communication line may include an actuator switch coupled to the second end, where the actuator switch toggles the laser distance meter between an on position and a standby position.

Example 8 may include the laser distance meter assembly of example 1 where the at least one communication line includes two communication lines. A first communication line may extend between the actuator switch and the display. The second communication line may extend between the actuator switch and the laser distance meter. The actuator switch may toggle the laser distance meter and the display between an on position and a standby position.

Example 9 may include the laser distance meter assembly of example 8 where the at least one communication line is wireless.

Example 10 may include the laser distance meter assembly of example 1 where the at least one housing includes a plurality of set screws disposed about the housing. The plurality of set screws may be configured to actuate the set of lasers within the housing.

Example 11 may include the laser distance meter assembly of example 1 where the at least one housing includes an exterior threaded surface and at least one weight ring configured to selective secure onto the exterior threaded surface.

Example 12 may include a laser distance meter with a laser housing. The laser housing may include a first laser housing end and a second laser housing end. The laser distance meter may include a mount housing with a first mount housing end and a second mount housing end. The mount housing may selectively attach to the second laser housing end via a mounting post disposed on the first mount housing end. The laser distance meter may include an actuator switch in communication with the laser housing. The actuator switch may be configured to toggle a set of lasers disposed within the laser housing between an on position and a standby position. The laser distance meter may include a display in communication with the actuator switch where the display is configured to simultaneously toggle with the set of lasers. The laser distance meter may include a housing mount assembly disposed on the mount housing. The housing mount assembly may include a fastener configured to selectively attach to a bow stabilizer mount.

Example 13 may include the laser distance meter of claim 12 where the set of lasers include a first laser disposed within the laser housing. The set of lasers may include a laser receiver configured to detect the first laser. The second laser may include a wavelength of 350 to 750 nanometers.

Example 14 may include the laser distance meter of example 12 where the laser housing includes a plurality of set screws disposed about the housing. The plurality of set screws are configured to actuate the set of lasers within the housing.

Example 15 may include the laser distance meter of example 12 where the laser distance meter includes at least one cord with a first end and a second end. The laser distance meter may include a cord output connector coupled to the first end where the cord output connector operably connects to the laser distance meter. The laser distance meter may include the actuator switch couple to the second end where the actuator switch toggles the laser distance meter between the on position and the standby position.

Example 16 may include the laser distance meter of example 12 where the housing mount assembly is disposed on the second mount housing end. The housing mount assembly may include a ball joint, a socket coupled to the second mount housing configured to receive the ball joint. The housing mount assembly may include a fastener disposed on the ball joint where the fastener selectively attaches to the bow stabilizer mount.

Example 17 may include a laser distance meter assembly. The laser distance meter assembly may include a bow with a proximate end, a distal end, a top end, and an opposed bottom end. The laser distance meter assembly May include a bow stabilizer Mount Disposed on the distill in And a laser distance meter. The laser distance meter may include at least one housing Where the least one housing selectively attaches To the bow stabilizer Mount Yeah a housing Mount assembly. The laser distance meter May include A set of lasers Disposed within the at least one housing And A display mounted onto a static site Couples Should the bow. The laser distance meter may include an actuator Switch In communication With The set of lasers And the display Where the actuator switch Toggles The display and the set of lasers Between An on position And a standby position.

Example 18 may include the laser distance meter of examples 17 where the set of lasers include a first laser disposed within the laser housing. The set of lasers may include a laser receiver configured to detect the first laser and a second laser. The second laser may include a wavelength of 350 to 750 nanometers.

Example 19 may include the laser distance meter assembly of example 17 where the actuator switch includes a pressure switch.

Example 20 may include the laser distance meter assembly of example 17 where the least one housing includes an exterior threaded surface and at least one weighted ring configured to selectively secure onto the exterior threaded surface.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although the embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

The invention claimed is:

1. A laser distance meter assembly to be mounted on a bow, comprising:
a laser distance meter, comprising:
at least one housing with a front face and a mounting face;
a set of lasers disposed to emanate from the front face, wherein at least one laser is visible;
a housing mount assembly configured to secure the laser distance meter to a bow stabilizer mount disposed on the bow;
a display removably mounted onto the bow;
an actuator switch removably mounted onto the bow; and
at least one communication line configured to transmit information between the actuator switch and the laser distance meter.

2. A laser distance meter assembly of claim 1, wherein the display is mounted via a display mount to a static sight secured to the bow.

3. A laser distance meter assembly of claim 1, wherein the laser distance meter comprises:
an outer housing;
an inner housing disposed within the outer housing; and
a front face and a mounting face disposed on opposing surfaces of the outer housing, wherein a lens is disposed on the front face and the housing mount assembly is disposed on the mounting face.

4. A laser distance meter assembly of claim 3, wherein the at least one housing comprises:
a laser housing with a first laser housing end and a second laser housing end;
a mount housing with a first mount housing end and a second mount housing end;
a mounting aperture disposed on the second laser housing end; and
a mounting post disposed on the first mount housing end configured to secure within the mounting aperture via one or more detents protruding from the mounting post.

5. A laser distance meter assembly of claim 4, wherein the housing mount assembly is disposed on the second mount housing end, the housing mount assembly comprises:
a ball joint;
a socket coupled to the second mount housing configured to receive the ball joint; and
a fastener disposed on the ball joint, wherein the fastener selectively attaches to the bow stabilizer mount.

6. A laser distance meter assembly of claim 4, wherein the laser housing comprises:
a first laser disposed within the laser housing;
a laser receiver configured to detect the first laser; and
a second laser, wherein the second laser comprises a wavelength of 350 to 750 nanometers.

7. A laser distance meter assembly of claim 1, wherein the at least one communication line comprises:
at least one cord with a first end and a second end;
a cord output connector coupled to the first end, the cord output connector operably connects to the laser distance meter; and
the actuator switch coupled to the second end, wherein the actuator switch toggles the laser distance meter between an on position and a standby position.

8. A laser distance meter assembly of claim 1, wherein the at least one communication line comprises:
two communication lines;
a first communication line extending between the actuator switch and the display; and
a second communication line extending between the actuator switch and the laser distance meter, wherein the actuator switch toggles the laser distance meter and the display between an on position and a standby position.

9. A laser distance meter assembly of claim 8, wherein the at least one communication line is wireless.

10. The laser distance meter assembly of claim 1, wherein the at least one housing comprises a plurality of set screws disposed about the housing, the plurality of set screws are configured to actuate the set of lasers within the housing.

11. The laser distance meter assembly of claim 1, wherein the at least one housing comprises:
an exterior threaded surface; and
at least one weight ring configured to selectively secure onto the exterior threaded surface.

12. A laser distance meter, comprising:
a laser housing with a first laser housing end and a second laser housing end;
a mount housing with a first mount housing end and a second mount housing end, the mount housing selectively coupled to the second laser housing end via a mounting post disposed on the first mount housing end;
an actuator switch in communication with the laser housing, wherein the actuator switch is configured to toggle a set of lasers disposed within the laser housing between an on position and a standby position;
a display in communication with the actuator switch, wherein the display is configured to simultaneously toggle with the set of lasers; and
a housing mount assembly disposed on the mount housing, wherein the housing mount assembly comprises a fastener configured to selectively attach to a bow stabilizer mount.

13. The laser distance meter of claim 12, the set of lasers comprise:
a first laser disposed within the laser housing;
a laser receiver configured to detect the first laser; and
a second laser, wherein the second laser comprises a wavelength of 350 to 750 nanometers.

14. The laser distance meter of claim 12, wherein the laser housing comprises a plurality of set screws disposed about the housing, the plurality of set screws are configured to actuate the set of lasers within the housing.

15. The laser distance meter of claim 12, further comprising:
at least one cord with a first end and a second end;
a cord output connector coupled to the first end, the cord output connector operably connects to the laser distance meter; and
the actuator switch coupled to the second end, wherein the actuator switch toggles the laser distance meter between the on position and the standby position.

16. The laser distance meter of claim 12, wherein the housing mount assembly is disposed on the second mount housing end, the housing mount assembly comprises:
a ball joint;
a socket coupled to the second mount housing configured to receive the ball joint; and
a fastener disposed on the ball joint, wherein the fastener selectively attaches to the bow stabilizer mount.

17. A laser distance meter assembly, comprising:
a laser distance meter comprising:
at least one housing, the at least one housing selectively attaches to a bow stabilizer mount via a housing mount assembly;
a set of lasers disposed within the at least one housing;
a display mounted onto a static sight coupled to the bow; and
an actuator switch in communication with the set of lasers and the display, wherein the actuator switch toggles the display and the set of lasers between an on position and a standby position.

18. The laser distance meter assembly of claim 17, the set of lasers comprise:
a first laser disposed within the laser housing;
a laser receiver configured to detect the first laser; and
a second laser, wherein the second laser comprises a wavelength of 350 to 750 nanometers.

19. The laser distance meter assembly of claim 17, wherein the actuator switch comprises a pressure switch.

20. The laser distance meter assembly of claim 17, wherein the at least one housing comprises:
an exterior threaded surface; and
at least one weight ring configured to selectively secure onto the exterior threaded surface.
